(19) United States
(12) Patent Application Publication
(10) Pub. No.: US 2025/0279505 A1
(43) Pub. Date: Sep. 4, 2025

(54) IMMERSION COOLING SYSTEMS AND METHODS FOR TRACTION BATTERY PACK SYSTEMS

(71) Applicant: FORD GLOBAL TECHNOLOGIES, LLC, Dearborn, MI (US)

(72) Inventor: Xiaogang ZHANG, Novi, MI (US)

(21) Appl. No.: 18/593,100

(22) Filed: Mar. 1, 2024

(51) Int. Cl. H01M 10/6568; H01M 10/613; H01M 10/625; H01M 10/635; H01M 50/367

(52) U.S. Cl. CPC H01M 10/6568; H01M 10/613; H01M 10/625; H01M 10/635; H01M 50/367; H01M 2220/20

(57) ABSTRACT

Immersion cooling systems are provided for managing thermal energy levels within a traction battery pack system. An exemplary immersion cooling system may include a flow control valve that is configured to control a flow of a cooling fluid (e.g., a dielectric fluid) through either a primary closed loop cooling circuit or a secondary closed loop cooling circuit of the immersion cooling system for thermally managing a battery module of a battery pack assembly. A control module may control a position of the flow control valve based at least on a temperature of the cooling fluid exiting the battery pack assembly. When the flow control valve directs the cooling fluid through the secondary closed loop cooling circuit, a portion of the primary closed loop cooling circuit is reserved for providing a dedicated gas exit flow path for expelling battery vent byproducts from the battery pack assembly.

### TECHNICAL FIELD

This disclosure relates generally to electrified vehicle traction battery pack systems, and more particularly to immersion cooling systems capable of managing battery cell thermal energy levels across multiple operating conditions of the traction battery pack system.

### BACKGROUND

An electrified vehicle includes a traction battery pack for powering electric machines and other electrical loads of the vehicle. The traction battery pack includes a plurality of battery cells and various other battery internal components that support electric vehicle propulsion.

### SUMMARY

A traction battery pack system according to an exemplary aspect of the present disclosure includes, among other things, a battery pack assembly including a battery module housed within an enclosure assembly, a primary closed loop cooling circuit that establishes a first flow path of an immersion cooling system, a secondary closed loop cooling circuit that establishes a second flow path of the immersion cooling system, a flow control valve arranged to control a flow of a cooling fluid along either the first flow path or the second flow path, and a control module programmed to control a position of the flow control valve based on a temperature of the cooling fluid exiting the battery pack assembly.

In a further non-limiting embodiment of the foregoing traction battery pack system, a temperature sensor is positioned within or near an outlet port of the battery pack assembly.

In a further non-limiting embodiment of either of the foregoing traction battery pack systems, the cooling fluid is a dielectric fluid.

In a further non-limiting embodiment of any of the foregoing traction battery pack systems, the control module is programmed to command the flow control valve to a first position for directing the cooling fluid along the first flow path when the temperature of the cooling fluid is less than or equal to a predefined temperature threshold, and is further programmed to command the flow control valve to a second position for directing the cooling fluid along the second flow path when the temperature of the cooling fluid is greater than the predefined temperature threshold.

In a further non-limiting embodiment of any of the foregoing traction battery pack systems, the first flow path extends through both a first battery internal fluid passageway and a second battery internal fluid passageway of the battery pack assembly. The second flow path extends through the first battery internal fluid passageway but not the second battery internal fluid passageway of the battery pack assembly.

In a further non-limiting embodiment of any of the foregoing traction battery pack systems, the second battery internal fluid passageway establishes a dedicated gas exit flow path for expelling a battery vent byproduct from the battery pack assembly when the temperature of the cooling fluid is greater than the predefined temperature threshold.

In a further non-limiting embodiment of any of the foregoing traction battery pack systems, the first battery internal fluid passageway extends between bottom sides of a plurality of battery cells of the battery module and an enclosure tray of the enclosure assembly, and the second battery internal fluid passageway extends between top sides of the plurality of battery cells of the battery module and an enclosure cover of the enclosure assembly.

In a further non-limiting embodiment of any of the foregoing traction battery pack systems, the primary closed loop cooling circuit of the immersion cooling system includes a first inlet port, a first battery internal fluid passageway, a first outlet port, a second inlet port, an external fluid passageway that connects between the first outlet port and the second inlet port, a second battery internal fluid passageway, and a second outlet port.

In a further non-limiting embodiment of any of the foregoing traction battery pack systems, the secondary closed loop cooling circuit of the immersion cooling system includes the first inlet port, the first battery internal fluid passageway, the first outlet port, and a return line.

In a further non-limiting embodiment of any of the foregoing traction battery pack systems, the immersion cooling system further includes a reservoir that is fluidly connected to the first inlet port.

In a further non-limiting embodiment of any of the foregoing traction battery pack systems, the immersion cooling system further includes a pump arranged between the reservoir and the first inlet port.

In a further non-limiting embodiment of any of the foregoing traction battery pack systems, the reservoir is positioned on an opposite side of the battery pack assembly from the flow control valve.

In a further non-limiting embodiment of any of the foregoing traction battery pack systems, a first heat exchanger is fluidly connected to the external fluid passageway, and a second heat exchanger is fluidly connected to the return line.

In a further non-limiting embodiment of any of the foregoing traction battery pack systems, a first position of the flow control valve is configured to divert the cooling fluid into the external fluid passageway of the primary closed loop cooling circuit, and a second position of the flow control valve is configured to divert the cooling fluid into the return line of the secondary closed loop cooling circuit.

In a further non-limiting embodiment of any of the foregoing traction battery pack systems, the immersion cooling system further includes a liquid-gas separator fluidly connected to the second outlet port.

In a further non-limiting embodiment of any of the foregoing traction battery pack systems, the liquid-gas separator is positioned on an opposite side of the battery pack assembly from the flow control valve.

In a further non-limiting embodiment of any of the foregoing traction battery pack systems, a temperature sensor is positioned within or near the second outlet port.

In a further non-limiting embodiment of any of the foregoing traction battery pack systems, the flow control valve is positioned outside of the enclosure assembly of the battery pack assembly.

In a further non-limiting embodiment of any of the foregoing traction battery pack systems, the flow control valve is positioned between an outlet port of the battery pack assembly and a heat exchanger of the primary closed loop cooling circuit.

A method according to another exemplary aspect of the present disclosure includes, among other things, circulating a cooling fluid along a first flow path provided by a primary closed loop cooling circuit of an immersion cooling system, monitoring a temperature of the cooling fluid as it travels along the first flow path, and when the temperature exceeds a predefined temperature threshold, circulating the cooling fluid along a second flow path provided by a secondary closed loop cooling circuit of the immersion cooling system. Circulating the cooling fluid along the second flow path includes preventing the cooling fluid from passing through a portion of the first flow path of the primary closed loop cooling circuit.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates an electrified vehicle.

FIG. 2 schematically illustrates an immersion cooling system of a traction battery pack system.

FIG. 3 schematically illustrates a first operation mode of the immersion cooling system of FIG. 2.

FIG. 4 schematically illustrates a second operation mode of the immersion cooling system of FIG. 2.

### DETAILED DESCRIPTION

This disclosure details immersion cooling systems for managing thermal energy levels within a traction battery pack system. An exemplary immersion cooling system may include a flow control valve that is configured to control a flow of a cooling fluid (e.g., a dielectric fluid) through either a primary closed loop cooling circuit or a secondary closed loop cooling circuit of the immersion cooling system for thermally managing a battery module of a battery pack assembly. A control module may control a position of the flow control valve based at least on a temperature of the cooling fluid exiting the battery pack assembly. When the flow control valve directs the cooling fluid through the secondary closed loop cooling circuit, a portion of the primary closed loop cooling circuit is reserved for providing a dedicated gas exit flow path for expelling battery vent byproducts from the battery pack assembly. These and other features are discussed in greater detail in the following paragraphs of this detailed description.

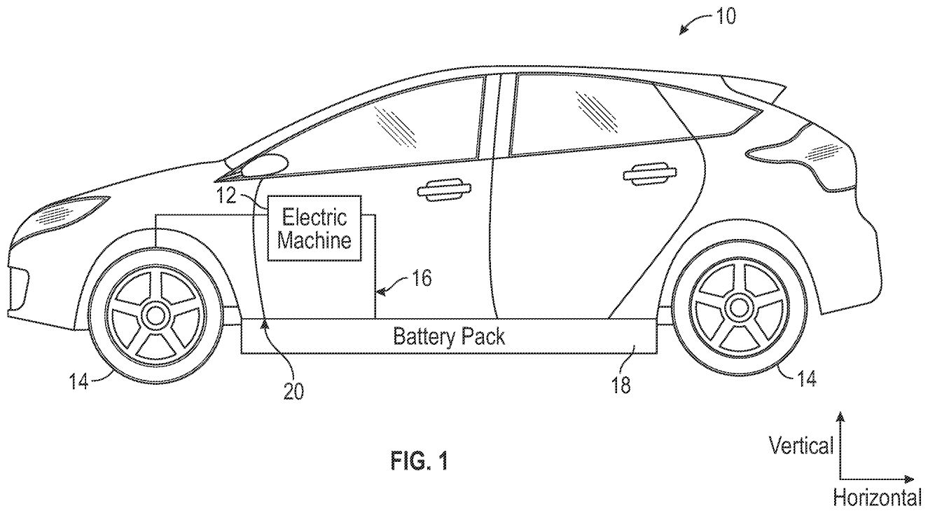

FIG. 1 schematically illustrates an electrified vehicle 10. The electrified vehicle 10 may include any type of electrified powertrain. In an embodiment, the electrified vehicle 10 is a battery electric vehicle (BEV). However, the concepts described herein are not limited to BEVs and could extend to other electrified vehicles, including, but not limited to, hybrid electric vehicles (HEVs), plug-in hybrid electric vehicles (PHEV's), fuel cell vehicles, etc. Therefore, although not specifically shown in the exemplary embodiment, the powertrain of the electrified vehicle 10 could be equipped with an internal combustion engine that can be employed either alone or in combination with other power sources to propel the electrified vehicle 10.

In the illustrated embodiment, the electrified vehicle 10 is depicted as a car. However, the electrified vehicle 10 could alternatively be a sport utility vehicle (SUV), a van, a pickup truck, or any other vehicle configuration. Although a specific component relationship is illustrated in the figures of this disclosure, the illustrations are not intended to limit this disclosure. The placement and orientation of the various components of the electrified vehicle 10 are shown schematically and could vary within the scope of this disclosure. In addition, the various figures accompanying this disclosure are not necessarily drawn to scale, and some features may be exaggerated or minimized to emphasize certain details of a particular component or system.

In the illustrated embodiment, the electrified vehicle 10 is a full electric vehicle propelled solely through electric power, such as by one or more electric machines 12, without assistance from an internal combustion engine. The electric machine 12 may operate as an electric motor, an electric generator, or both. The electric machine 12 receives electrical power and can convert the electrical power to torque for driving one or more wheels 14 of the electrified vehicle 10.

A voltage bus 16 may electrically couple the electric machine 12 to a traction battery pack system 18. The traction battery pack system 18 is an exemplary electrified vehicle battery. The traction battery pack system 18 may include a high voltage traction battery pack assembly that includes a plurality of battery cells capable of outputting electrical power to power the electric machine 12 and/or other electrical loads of the electrified vehicle 10. Other types of energy storage devices and/or output devices could alternatively or additionally be used to electrically power the electrified vehicle 10.

The traction battery pack system 18 may be secured to an underbody 20 of the electrified vehicle 10. However, the traction battery pack system 18 could be located elsewhere on the electrified vehicle 10 within the scope of this disclosure.

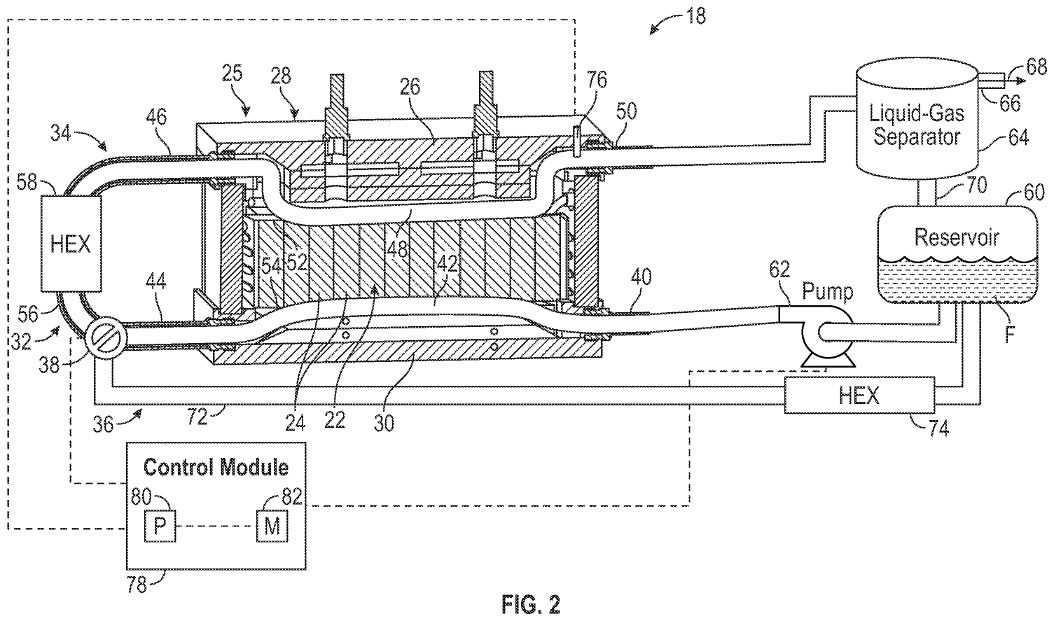

FIG. 2 illustrates additional details associated with the traction battery pack system 18 of the electrified vehicle 10 of FIG. 1. The traction battery pack system 18 may include one or more battery modules 22 (e.g., battery assemblies or groupings of rechargeable battery cells 24) capable of outputting electrical power to power the electric machine 12 and/or other electrical loads of the electrified vehicle 10.

The battery cells 24 may be stacked side-by-side along a stack axis to construct a grouping of battery cells 24, sometimes referred to as a “cell stack.” The total number of battery modules 22 and battery cells 24 provided within the traction battery pack system 18 is not intended to limit this disclosure.

In an embodiment, the battery cells 24 of each battery module 22 are prismatic, lithium-ion cells. However, battery cells having other geometries (cylindrical, pouch, etc.), other chemistries (nickel-metal hydride, lead-acid, etc.), or both could alternatively be utilized within the scope of this disclosure.

The battery modules 22 and various other battery internal components (e.g., bussed electrical center, battery electric control module, wiring, connectors, etc.) may be housed inside of an enclosure assembly 28 of the traction battery pack system 18. Together, the battery modules 22 and the enclosure assembly 28 may establish a battery pack assembly 25 of the traction battery pack system 18.

The battery modules 22 may be arranged in one or more rows inside the enclosure assembly 28. Although only a single battery module 22 having twelve battery cells 24 is shown in FIG. 2, other configurations are possible. Accordingly, it should be appreciated that the traction battery pack system 18 could include a greater number of battery modules 22 and/or a greater or fewer number of battery cells 24 within the scope of this disclosure.

Although shown schematically, the enclosure assembly 28 may embody a multi-piece design that includes an enclosure cover 26 and an enclosure tray 30 that are joined together to establish an interior for housing the battery module(s) 22. The size, shape, and overall configuration of the enclosure assembly 28 is not intended to limit this disclosure. In an embodiment, the enclosure assembly 28 provides a sealed enclosure around the battery module(s) 22 and other battery internal components of the battery pack assembly 25.

The traction battery pack system 18 may additionally include an immersion cooling system 32. As further detailed below, the immersion cooling system 32 may include a primary closed loop cooling circuit 34 and a secondary closed loop cooling circuit 36 arranged for thermally managing the battery module 22 and for managing battery vent gases and other byproducts during different operating conditions of the traction battery pack system 18. Although schematically shown, the various subcomponents of the immersion cooling system 32 can be fluidly interconnected by various conduits or passages such as tubes, hoses, pipes, etc.

The immersion cooling system 32 may be configured for directly contacting individual surfaces of the battery cells 24 by circulating a cooling fluid F along a flow path established by either the primary closed loop cooling circuit 34 or the secondary closed loop cooling circuit 36. In an embodiment, the cooling fluid F is a dielectric fluid. However, other fluids could be utilized within the scope of this disclosure.

A flow control valve 38 may be configured to control the flow of the cooling fluid F along the respective flow path provided by either the primary closed loop cooling circuit 34 or the secondary closed loop cooling circuit 36 depending on a current operating condition of the traction battery pack system 18. The flow control valve 38 may be a multi-position solenoid valve (e.g., a three-way valve) or any other suitable type of electronically controllable valve.

The primary closed loop cooling circuit 34 of the immersion cooling system 32 may include a first inlet port 40, a first battery internal fluid passageway 42, a first outlet port 44, a second inlet port 46, a second battery internal fluid passageway 48, and a second outlet port 50. The first battery internal fluid passageway 42 may extend between bottom sides 54 of the battery cells 24 of the battery module 22 and the enclosure tray 30, and the second battery internal fluid passageway 48 may extend between top sides 52 of the battery cells 24 of the battery module 22 and the enclosure cover 26. An external fluid passageway 56 may connect between the first outlet port 44 and the second inlet port 46. The external fluid passageway 56 may be fluidly connected to the flow control valve 38 and to a first heat exchanger 58 (e.g., a first fluid-to-air heat exchanger), which are both disposed outside of the enclosure assembly 28 of the battery pack assembly 25.

The first inlet port 40 may be fluidly connected to a reservoir 60 that is configured for storing the cooling fluid F. A pump 62 may be operated to selectively circulate the cooling fluid F through the respective flow path of either the primary closed loop cooling circuit 34 or the secondary closed loop cooling circuit 36. In an embodiment, the pump 62 is located between the reservoir 60 and the first inlet port 40. However, the pump 62 could be located elsewhere within the scope of this disclosure. The pump 62 may be an electrically powered fluid pump or another type of pump within the scope of this disclosure.

The reservoir 60 and the pump 62 may both be located outside of the enclosure assembly 28 of the battery pack assembly 25. In an embodiment, the reservoir 60 and the pump 62 are located on an opposite side of the enclosure assembly 28 from the flow control valve 38 and the first heat exchanger 58.

The secondary closed loop cooling circuit 36 of the immersion cooling system 34 may include the first inlet port 40, the first battery internal fluid passageway 42, the first outlet port 44, and a return line 72. Some pathways (e.g., the first inlet port 40, the first battery internal fluid passageway 42, and the first outlet port 44) of the immersion cooling system 34 are thus shared as part of both the primary closed loop cooling circuit 34 and the secondary closed loop cooling circuit 36. The return line 72 may connect between the flow control valve 38 and the reservoir 60. A second heat exchanger 74 (e.g., a second fluid-to-air heat exchanger) may be provided within the return line 72. The return line 72 and the second heat exchanger 74 are both disposed outside of the enclosure assembly 28 of the battery pack assembly 25.

When the cooling fluid F is circulated along a flow path provided by the primary closed loop cooling circuit 34, the pump 62 may be operated to selectively force the cooling fluid F through the first inlet port 40 and then through the first battery internal fluid passageway 42. The cooling fluid F may pick up heat from the battery cells 24 through convective heat transfer as it flows across the first battery internal fluid passageway 42. The cooling fluid F may then exit the battery pack assembly 25 through the first outlet port 44. The flow control valve 38 may then direct the cooling fluid F into the external fluid passageway 56. The cooling fluid F may then pass through the first heat exchanger 58 from within the external fluid passageway 56. Thermal energy picked up from the battery cells 24 while passing through the first battery internal fluid passageway 42 may be transferred from the cooling fluid F to ambient air within the first heat exchanger 58.

The cooling fluid F may then flow through the second inlet port 46 prior to entering the second battery internal fluid passageway 48. The cooling fluid F may pick up additional heat from the battery cells 24 through convective heat transfer as it flows through the second battery internal fluid passageway 48. The cooling fluid F may then exit the second battery internal fluid passageway 48 through the second outlet port 50.

The second outlet port 50 may be fluidly connected to a liquid-gas separator 64. Gas may be separated from the cooling fluid F within the liquid-gas separator 64 and may be exhausted to atmosphere through a gas outlet 66 as schematically shown at arrow 68. As schematically shown, the liquid-gas separator 64 may be located outside of the enclosure assembly 28 of the battery pack assembly 25 and may be positioned on an opposite side of the enclosure assembly 28 from the first heat exchanger 58 and the flow control valve 38. The degassed cooling fluid F may be returned to the reservoir 60 within a connection line 70 that is fluidly connected to both the liquid-gas separator 64 and the reservoir 60.

When the cooling fluid F is circulated along a flow path provided by the secondary closed loop cooling circuit 36, the pump 62 may be operated to selectively force the cooling fluid F through the first inlet port 40 and then into the first battery internal fluid passageway 42. The cooling fluid F may pick up heat from the battery cells 24 through convective heat transfer as it flows through the first battery internal fluid passageway 42. The cooling fluid F may exit the first battery internal fluid passageway 42 through the first outlet port 44. The flow control valve 38 may then direct the cooling fluid F into the return line 72. The cooling fluid F may pass through the second heat exchanger 74 from within the return line 72. Thermal energy picked up from the battery cells 24 while passing through the first battery internal fluid passageway 42 may be transferred from the cooling fluid F to ambient air within the second heat exchanger 74 prior to returning the cooling fluid F to the reservoir 60. Notably, the cooling fluid F does not pass through the second battery internal fluid passageway 48 while being circulated through the secondary closed loop cooling circuit 36.

The immersion cooling system 32 may further include one or more temperature sensors 76 and a control module 78. The temperature sensor 76 may be configured to sense the temperature of the cooling fluid F. In an embodiment, the temperature sensor 76 is provided within or near the second outlet port 50. The temperature sensor 76 may therefore be arranged to sense the temperature of the cooling fluid F exiting the enclosure assembly 28 of the battery pack assembly 25.

The control module 78 may be operably connected to the pump 62, the flow control valve 38, and the temperature sensor 76 and may be programmed to control operations of the immersion cooling system 32 for thermally managing the battery module 22 of the traction battery pack system 18. The control module 78 may include both hardware and software and could be part of an overall vehicle control system, such as a vehicle system controller (VSC), or could alternatively be a stand-alone controller or collection of controllers that are separate from the VSC. It should therefore be understood that the control module 78 and one or more additional controllers operably coupled thereto can collectively be referred to as a “control module” within the scope of this disclosure.

The control module 78 may be programmed with executable instructions for interfacing with and commanding operation of various components of the immersion cooling system 32 as part of a control strategy for controlling the flow path of the cooling fluid F. The control module 78 may include a processor 80 and non-transitory memory 82 for executing the various control strategies and modes associated with the immersion cooling system 32. The processor 80 may be a custom made or commercially available processor, a central processing unit (CPU), or generally any device for executing software instructions. The memory 82 may include any one or combination of volatile memory elements and/or nonvolatile memory elements. The processor 80 may be operably coupled to the memory 82 and may be configured to execute one or more programs stored in the memory 82 based on the various inputs received from other devices (e.g., inputs from the temperature sensor 76) associated with the immersion cooling system 32.

The temperature sensor 76 may be configured to periodically provide input signals to the control module 78 that are indicative of the temperature of the cooling fluid F exiting the battery pack assembly 25 through the second outlet port 50. In response to receiving the input signals, the control module 78 may control a position of the flow control valve 38 in order to direct the cooling fluid F along a desired flow path for thermally managing the battery cells 24 and/or for responding to a battery thermal event that could occur within one or more of the battery cells 24. A battery thermal event may occur, for example, during over-charging conditions, over-discharging conditions, or other conditions and can cause one or more of the battery cells 24 to expel battery vent byproducts, which can include gases, effluent particles, and/or other vent byproducts.

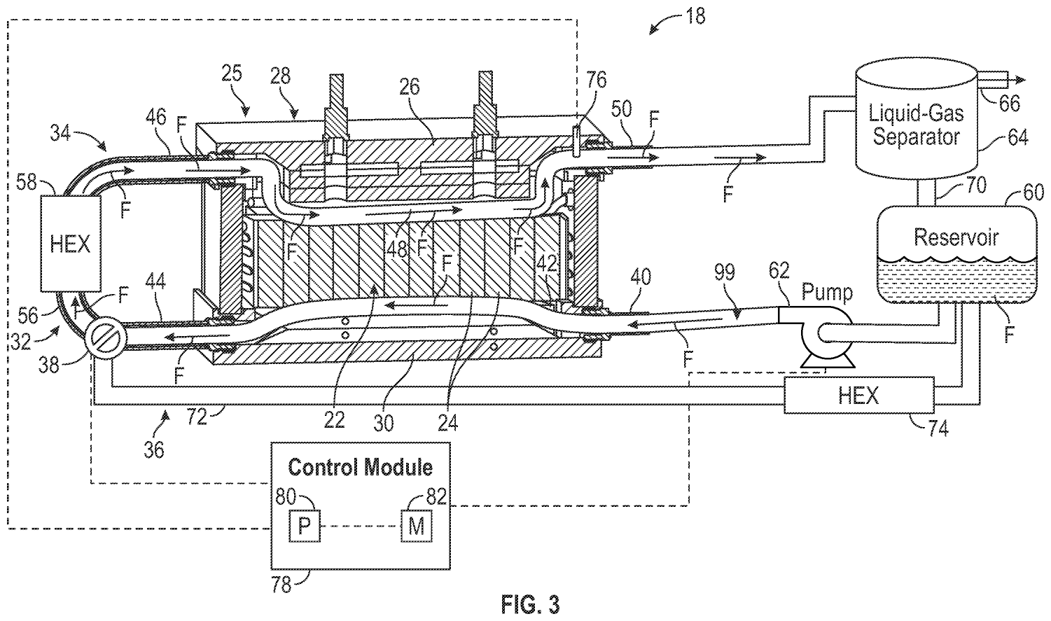

A first operation mode of the immersion cooling system 32 that can be commanded by the control module 78 is schematically illustrated in FIG. 3. The first operation mode may be considered a default mode of the immersion cooling system 32 and can occur when the temperature input signals received from the temperature sensor 76 indicate a temperature of the cooling fluid F that is less than or equal to a predefined temperature threshold (e.g., about 150 degrees C. or some other suitable temperature selected based on design specific factors). When this occurs, the control module 78 may command the flow control valve 38 to a first position for directing the cooling fluid F along a first flow path 99 provided by the primary closed loop cooling circuit 34. The cooling fluid F may therefore flow through both the first battery internal fluid passageway 42 and the second battery internal fluid passageway 48 for thermally managing the battery cells 24 of the battery module 22 during normal operating conditions of the traction battery pack system 18. Notably, flow of the cooling fluid F is blocked from entering the return line 72 of the secondary closed loop cooling circuit 36 during the first operation mode.

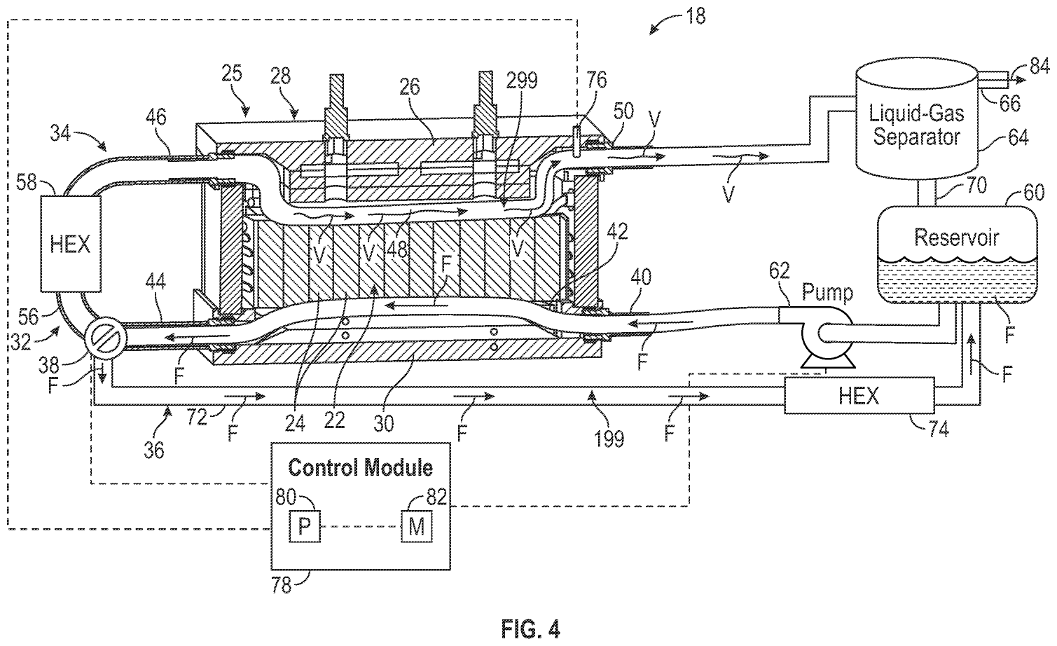

A second operation mode of the immersion cooling system 32 that can be commanded by the control module 78 is schematically illustrated in FIG. 4. The second operation mode may be specifically adapted for responding to a battery thermal event that could occur within one or more of the battery cells 24 of the battery module 22. For example, when the temperature input signals received from the temperature sensor 76 indicate a temperature that is greater than or equal to the predefined temperature threshold (e.g., about 150 degrees C. or some other suitable temperature selected based on design specific factors), the control module 78 may command the flow control valve 38 to a second position for directing the cooling fluid F along a second flow path 199 provided by the secondary closed loop cooling circuit 36. The cooling fluid F may therefore flow through only the first battery internal fluid passageway 42 and not the second battery internal fluid passageway 48 for thermally managing the battery cells 24. Notably, flow of the cooling fluid F is blocked from entering the external fluid passageway 56 of the primary closed loop cooling circuit 34 by the flow control valve 38 during the second operation mode.

Since the cooling fluid F is not circulated through the second battery internal fluid passageway 48 during the second operation mode, the second battery internal fluid passageway 48 may provide a dedicated gas exit flow path 299 for expelling battery vent byproducts V released by one or more of the battery cells 24 from the battery pack assembly 25 during a battery thermal event. An excessive pressure build-up inside the enclosure assembly 28 of the battery pack assembly 25 may therefore be prevented during the battery thermal event that necessitated operation of the immersion cooling system in the second operation mode.

The battery vent byproducts V may travel through the second outlet port 50 from the second internal fluid passageway 48. The battery vent byproducts V may be exhausted to atmosphere through the gas outlet 66 of the liquid-gas separator 64 as schematically shown at arrow 84.

Once the battery vent byproducts V have been expelled from the battery pack assembly 25 and the temperature sensed by the temperature sensor 76 drops to being less than or equal to the predefined temperature threshold, the control module 78 may command the flow control valve 38 back to the first position for directing the cooling fluid F through the primary closed loop cooling circuit 34. Normal operation of the immersion cooling system 32 may therefore be re-established following the battery thermal event.

The control module 78 may be programmed to control the immersion cooling system 32 in the second operation mode for a predefined amount of time (e.g., about 20 seconds or some other suitable amount of time selected based on design specific factors). The predefined amount of time is a sufficient amount of time to allow the battery vent byproducts V to be expelled from the battery pack assembly 25 without creating an excessive pressure situation inside the enclosure assembly 28.

The exemplary traction battery packs of this disclosure include an immersion cooling system for providing enhanced battery cell thermal management and vent gas management. A flow path of a cooling fluid used within the immersion cooling system may be controlled based on a temperature of the cooling fluid, thereby reserving battery internal space for providing a gas exit flow path for expelling vent gases from the battery pack and preserving thermal performance during battery thermal events.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A traction battery pack system, comprising:
a battery pack assembly including a battery module housed within an enclosure assembly;
a primary closed loop cooling circuit that establishes a first flow path of an immersion cooling system;
a secondary closed loop cooling circuit that establishes a second flow path of the immersion cooling system;
a flow control valve arranged to control a flow of a cooling fluid along either the first flow path or the second flow path; and
a control module programmed to control a position of the flow control valve based on a temperature of the cooling fluid exiting the battery pack assembly.

2. The traction battery pack system as recited in claim 1, comprising a temperature sensor positioned within or near an outlet port of the battery pack assembly.

3. The traction battery pack system as recited in claim 1, wherein the cooling fluid is a dielectric fluid.

4. The traction battery pack system as recited in claim 1, wherein the control module is programmed to command the flow control valve to a first position for directing the cooling fluid along the first flow path when the temperature of the cooling fluid is less than or equal to a predefined temperature threshold and is further programmed to command the flow control valve to a second position for directing the cooling fluid along the second flow path when the temperature of the cooling fluid is greater than the predefined temperature threshold.

5. The traction battery pack system as recited in claim 4, wherein the first flow path extends through both a first battery internal fluid passageway and a second battery internal fluid passageway of the battery pack assembly, and further wherein the second flow path extends through the first battery internal fluid passageway but not the second battery internal fluid passageway of the battery pack assembly.

6. The traction battery pack system as recited in claim 5, wherein the second battery internal fluid passageway establishes a dedicated gas exit flow path for expelling a battery vent byproduct from the battery pack assembly when the temperature of the cooling fluid is greater than the predefined temperature threshold.

7. The traction battery pack system as recited in claim 5, wherein the first battery internal fluid passageway extends between bottom sides of a plurality of battery cells of the battery module and an enclosure tray of the enclosure assembly, and the second battery internal fluid passageway extends between top sides of the plurality of battery cells of the battery module and an enclosure cover of the enclosure assembly.

8. The traction battery pack system as recited in claim 1, wherein the primary closed loop cooling circuit of the immersion cooling system includes a first inlet port, a first battery internal fluid passageway, a first outlet port, a second inlet port, an external fluid passageway that connects between the first outlet port and the second inlet port, a second battery internal fluid passageway, and a second outlet port.

9. The traction battery pack system as recited in claim 8, wherein the secondary closed loop cooling circuit of the immersion cooling system includes the first inlet port, the first battery internal fluid passageway, the first outlet port, and a return line.

10. The traction battery pack system as recited in claim 9, wherein the immersion cooling system further includes a reservoir that is fluidly connected to the first inlet port.

11. The traction battery pack system as recited in claim 10, wherein the immersion cooling system further includes a pump arranged between the reservoir and the first inlet port.

12. The traction battery pack system as recited in claim 10, wherein the reservoir is positioned on an opposite side of the battery pack assembly from the flow control valve.

13. The traction battery pack system as recited in claim 9, comprising a first heat exchanger fluidly connected to the external fluid passageway, and a second heat exchanger fluidly connected to the return line.

14. The traction battery pack system as recited in claim 9, wherein a first position of the flow control valve is configured to divert the cooling fluid into the external fluid passageway of the primary closed loop cooling circuit, and a second position of the flow control valve is configured to divert the cooling fluid into the return line of the secondary closed loop cooling circuit.

15. The traction battery pack system as recited in claim 8, wherein the immersion cooling system further includes a liquid-gas separator fluidly connected to the second outlet port.

16. The traction battery pack system as recited in claim 15, wherein the liquid-gas separator is positioned on an opposite side of the battery pack assembly from the flow control valve.

17. The traction battery pack system as recited in claim 8, comprising a temperature sensor positioned within or near the second outlet port.

18. The traction battery pack system as recited in claim 1, wherein the flow control valve is positioned outside of the enclosure assembly of the battery pack assembly.

19. The traction battery pack system as recited in claim 18, wherein the flow control valve is positioned between an outlet port of the battery pack assembly and a heat exchanger of the primary closed loop cooling circuit.

20. A method, comprising:
circulating a cooling fluid along a first flow path provided by a primary closed loop cooling circuit of an immersion cooling system;
monitoring a temperature of the cooling fluid as it travels along the first flow path; and
when the temperature exceeds a predefined temperature threshold, circulating the cooling fluid along a second flow path provided by a secondary closed loop cooling circuit of the immersion cooling system,
wherein circulating the cooling fluid along the second flow path includes preventing the cooling fluid from passing through a portion of the first flow path of the primary closed loop cooling circuit.
